(19) United States
(12) Patent Application Publication
(10) Pub. No.: US 2026/0186695 A1
(43) Pub. Date: Jul. 2, 2026

(54) REAL-TIME DATA STORAGE METHOD USING FLASH EEPROM EMULATION AND A STORAGE DEVICE INCLUDING THE SAME

(71) Applicant: HYUNDAI AUTOEVER CORP., Seoul (KR)

(72) Inventor: Eun Su Jun, Seoul (KR)

(73) Assignee: HYUNDAI AUTOEVER CORP., Seoul (KR)

(21) Appl. No.: 19/431,867

(22) Filed: Dec. 23, 2025

(30) Foreign Application Priority Data
Dec. 30, 2024 (KR) 10-2024-0200634

(51) Int. Cl. G06F 3/06

(52) U.S. Cl. CPC G06F 3/0655; G06F 3/0604; G06F 3/0679

(57) ABSTRACT

A real-time data storage method using flash electrically erasable programmable read-only memory (EEPROM) emulation includes defining a block header and determining a state of a block as one of an alternative state, a write start state, a write end state, an active state, a full state, or an inactive state based on a state of the block header. The real-time data storage method also includes defining a data header as at least one of start of a frame, a first state, a second state, checksum, or verification high/low (H/L). The real-time data storage method additionally includes determining a state of the data based on the state of the data header. The real-time data storage method further includes and periodically performing storage logic including data storage request and request result acquisition to store the data in real time.

### CROSS REFERENCE TO RELATED APPLICATION

This application claims the benefit of and priority to Korea Patent Application No. 10-2024-0200634, filed on Dec. 30, 2024, the entire contents of which are hereby incorporated herein by reference.

### FIELD OF TECHNOLOGY

The present disclosure relates to a real-time data storage method using flash EEPROM emulation and a storage device including the same.

### BACKGROUND

Embedded systems primarily process and store data using a random access memory (RAM), which is a volatile memory, and a flash electrically erasable programmable read-only memory (EEPROM), which is a non-volatile memory. The RAM can process data at high speed, but has a volatile property meaning that all pieces of data are lost when power is cut off. On the other hand, since the flash EEPROM, which is a non-volatile memory, can retain data even when power is cut off, the flash EEPROM is used for data backup and long-term storage.

In particular, in the field of application requiring real-time data storage, such as an electronic control unit (ECU) of an automotive, technology for reliably storing data from a RAM, in a non-volatile memory, is essential. Recording and maintaining key data, such as a vehicle driving state, a mileage, and a motor state, in real time is crucial for system reliability and safety.

Flash EEPROM emulation is a technique for storing data using a data flash memory of a microcomputer as an EEPROM, and a method of storing data in an external EEPROM is used in a vehicle to preserve data stored in a RAM, which is volatile when power is turned off.

However, since the external EEPROM requires an external integrated circuit (IC) and an additional circuit, a controller manufacture cost increases. As an alternative, a technique for storing data using a data flash memory of a microcomputer as an external EEPROM is being used.

In the case of the data flash memory, since the entire memory becomes unusable when even one area reaches the end of its lifespan, a scheme for storing data by assigning a larger area than an RAM and swapping blocks is used.

However, in the case of a data flash memory, data needs to be written using an internal module in a microcomputer instead of using a scheme of accessing and directly writing data as in a general RAM, which consumes significant time, and therefore, a flash EEPROM emulation (FEE) technique typically stores all pieces of RAM data in a flash memory when a controller is shut down.

Further, in automotive environments, real-time data storage logic needs to be implemented since normal shutdown may not be possible or data may need to be stored immediately in real time.

The statements in this section merely provide background information related to the present disclosure and may not constitute prior art.

### SUMMARY

Aspects of the present invention provide a storage method and storage device that overcome the limitations of Flash EEPROM emulation technology and are optimized for real-time data storage and management.

According to an aspect of the present disclosure, a real-time data storage method using flash EEPROM emulation is provided. The real-time data storage method includes defining a block header and determining a state of a block as one of an alternative state, a write start state, a write end state, an active state, a full state, or an inactive state based on a state of the block header. The real-time data storage method also includes defining a data header as at least one of start of a frame, a first state, a second state, checksum, or verification high/low (H/L). The real-time data storage method additionally includes determining a state of the data based on the state of the data header and periodically performing storage logic including data storage request and request result acquisition to store the data in real time, wherein the storage logic includes finding an empty space to which new data can be written in the block. The real-time data storage method further includes writing a first header including the start of the frame and the first state to the empty space when the empty space is found, writing data, and calculating a checksum using the data. The real-time data storage method further still includes writing a second header including the second state and the checksum when the checksum is the same, and writing the data to the verification H/L of existing data to process the data as invalid data.

In an aspect, the data storage request may include calculating a checksum, setting a value of a request flag when a state of a real-time RAM state machine is a ready state, setting a request result to a pending state, and returning a request success. The request result acquisition may include returning the request result; and setting the request result to a ready state when the request result is not pending.

In an aspect, the real-time data storage method may further include returning a request failure when a state of a real-time RAM state machine is not a ready state.

In an aspect, a state of a real-time RAM state machine may include a ready state, a request state 1, a request state 2, and a pending erase state.

In an aspect, a state of the real-time RAM state machine determined by a real-time RAM state machine task may include checking a current state of a real-time RAM state machine; and performing one of a ready state logic, a request state 1 logic, a request state 2 logic, or a pending erase state logic based on the current state of the real-time RAM state machine.

In an aspect, performing the one of the ready state logic, the request state 1 logic, the request state 2 logic, or the pending erase state logic may include performing the ready state logic based on the current state of the real-time RAM state machine being the ready state. The ready state logic may include determining whether the value of the request flag is 1, changing the state of the real-time RAM state machine to request state 1 when the value of the request flag is 1, or clearing the value of the request flag.

In an aspect, performing the one of the ready state logic, the request state 1 logic, the request state 2 logic, or the pending erase state logic may include performing the request state 1 logic based on the current state of the real-time RAM state machine being request state 1. Performing the request state 1 logic may include performing write data step 1 and changing the state of the real-time RAM state machine to a ready state or request state 2 according to a result of performing write data step 1.

In an aspect, performing the one of the ready state logic, the request state 1 logic, the request state 2 logic, or the pending erase state logic may include performing the request state 2 logic based on the current state of the real-time RAM state machine being request state 2. Performing the request 2 logic may include performing write data step 2 and changing the state of the real-time RAM state machine to a pending erase state.

In an aspect, performing the one of the ready state logic, the request state 1 logic, the request state 2 logic, or the pending erase state logic may include performing the pending erase state logic based on the current state of the real-time RAM state machine being a pending erase state. Performing the pending erase sate logic may include determining whether the erasure is completed and changing the state of the real-time RAM state machine to a ready state when the erasure is completed.

In an aspect, performing the write data step 1 may include calculating a checksum of the data; determining whether the checksums of the data are the same, checking a remaining space of the current block when the checksums of the data are the same, writing the data to the current block when the remaining space is not full; setting the existing data as invalid, and setting the request result as a request success.

In an aspect, performing the write data step 1 may include calculating a checksum of the data; determining whether the checksums of the data are the same, and setting the request result as data changed when the checksums of the data are different.

In an aspect, performing the write data step 1 may include calculating a checksum of the data; determining whether the checksums of the data are the same, checking a remaining space of the current block when the checksums of the data are the same, writing the data to a block next to the block when the remaining space is full, and setting write data step 2.

In an aspect, performing the write data step 2 may include writing a full value to a current block header, writing a write end value to a block header next to the current block header, requesting deletion of the full value of the current block, and setting the request result as a request success.

In an aspect, the real-time data storage method may further include an initialization step of processing the data according to the state of the block.

In an aspect, the initialization step may include determining whether block x is in an active state and block y is in an inactive state, the block including block x and block y, finding valid data in the active block when block x is in the active state and block y is in the inactive state, and restoring the valid data into a RAM.

In an aspect, the initialization step may include determining whether block x is in an active state and block y is in an inactive state, the block including block x and block y. The initialization step may also include determining whether block x is in the active state and block y is in a write start state when block x is not in the active state and block y is not in the inactive state, performing block swap and setting block x to an alternative state and block y to the active state when the block x is in the active state and block y is in the write start state, and restoring the valid data into a RAM.

In an aspect, the initialization step may include determining whether block x is in an active state and block y is in an inactive state, the block including block x and block y. The initialization step may also include determining whether block x is in the active state and block y is in a write start state when block x is not in the active state and block y is not in the inactive state, determining whether block x is in the inactive state and block y is in the write start state or the active state when block x is not in the active state and block y is not in the inactive state, setting block x to an alternative state and block y to the active state when the block x is in the inactive state and block y is in the write start state or the active state, and restoring the valid data into a RAM.

In an aspect, the initialization step may include determining whether block x is in an active state and block y is in an inactive state, the block including block x and block y. The initialization step may also include determining whether block x is in the active state and block y is in a write start state when block x is not in the active state and block y is not in the inactive state, determining whether block x is in the inactive state and block y is in the write start state or the active state when block x is not in the active state and block y is not in the inactive state, deleting the block x and the block y when block x is not in the inactive state and block y is not in the write start state or the active state, and setting block x to the active state and block y to an alternative state.

According to another aspect, a non-transitory computer-readable medium having instructions stored thereon is provided. The instructions, when executed by one or more processors, cause the one or more processors to perform the real-time data storage method using flash EEPROM emulation.

According to yet another aspect, a real-time data storage device for emulating a flash EEPROM is provided. The real-time data storage device is configured to perform the real-time data storage method using flash EEPROM emulation.

As described above, according to aspects of the present embodiment, it is possible to provide the storage method and storage device that overcome the limitations of flash EEPROM emulation technology and are optimized for real-time data storage and management.

### BRIEF DESCRIPTION OF THE DRAWINGS

In order to enable one having ordinary skill in the art to understand the present disclosure, various forms of the present disclosure are described given by way of example with reference to the accompanying drawings, in which:

FIG. 1 is a diagram illustrating flash EEPROM emulation according to an embodiment.

FIG. 2 is a diagram illustrating flash EEPROM emulation according to an embodiment.

FIG. 3 is a diagram illustrating flash EEPROM emulation according to an embodiment.

FIG. 4 is a diagram illustrating a block and data definition according to an embodiment.

FIG. 5 is a diagram illustrating a block and data definition according to an embodiment.

FIG. 6 is a diagram illustrating a block and data definition according to an embodiment.

FIG. 7 is a diagram illustrating a logical sequence for storing data according to an embodiment.

FIG. 8 is a diagram illustrating a sequence of a data storage request according to an embodiment.

FIG. 9 is a diagram illustrating a sequence of request result acquisition according to an embodiment.

FIG. 10 is a diagram illustrating a sequence for a real-time state machine according to an embodiment.

FIG. 11 is a diagram illustrating a sequence for write data step 1 according to an embodiment.

FIG. 12 is a diagram illustrating a sequence for write data step 2 according to an embodiment.

FIG. 13 is a diagram illustrating blocks according to an embodiment.

FIG. 14 is a diagram illustrating blocks according to an embodiment.

FIG. 15 is a diagram illustrating blocks according to an embodiment.

FIG. 16 is a diagram illustrating blocks according to an embodiment.

FIG. 17 is a diagram illustrating blocks according to an embodiment.

FIG. 18 is a diagram illustrating blocks according to an embodiment.

### DETAILED DESCRIPTION

Hereinafter, embodiments of the present disclosure are described in detail with reference to the accompanying drawings. Where components in respective drawings are denoted by reference numerals, it should be noted that the same components are denoted by the same reference numerals as much as possible even when the components are shown on different drawings. Further, in the following description, where it was determined that a detailed description of related known configurations or functions would obscure the gist of the present disclosure, the detailed description thereof has been omitted.

Further, terms such as first, second, A, B, (a), and (b) may be used to described the components of the present disclosure. These terms are merely intended to distinguish the components from other components, and the nature, order, or sequence of the components is not limited by the terms. When a component is described as being “connected” or “coupled” to another component, it should be understood that the component may be directly connected or coupled to the other component, but another component may also be “connected” or “coupled” between respective components.

When a component, controller, device, element, apparatus, circuit, unit, or the like of the present disclosure is described as having a purpose or performing an operation, function, or the like, the component, controller, device, element, apparatus, circuit, unit or the like should be considered herein as being “configured to” meet that purpose or to perform that operation or function. Each component, controller, device, element, apparatus, circuit, unit, and the like may separately embody or be included with a processor and a memory, such as a non-transitory computer readable media, as part of the apparatus.

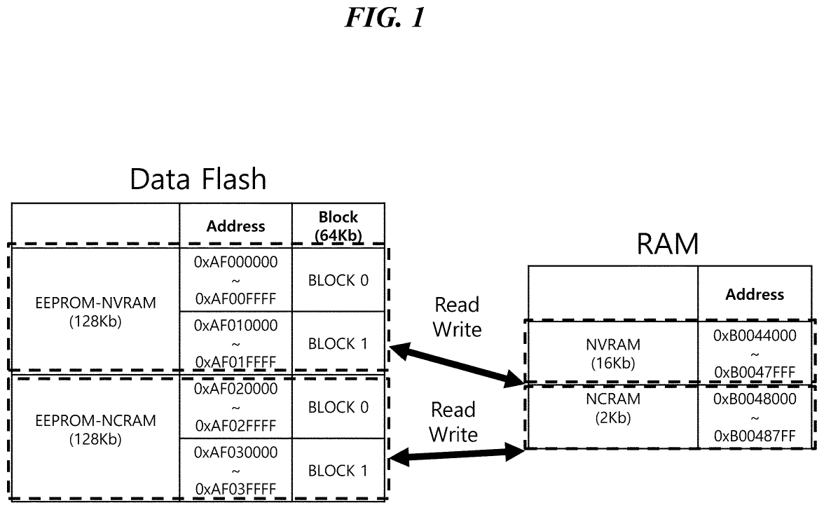

FIG. 1 is a diagram illustrating flash electrically erasable programmable read-only memory (EEPROM) emulation according to an embodiment.

Referring to FIG. 1, a data flash memory is on the left, and a random access memory (RAM) is on the right.

The data flash memory may be divided into two (e.g., 128 kb) blocks (Block 0 and Block 1).

The RAM may be divided into an NVRAM (e.g., 16 kb) and an NCRAM (e.g., 2 kb), each of which may have a specific address range.

The NVRAM (e.g., 16 kb) may process data that is continuously used and stored within the RAM and may process data by reading/writing the data from/to a flash memory (Block 0 and Block 1).

The NCRAM (e.g., 2 kb) may process relatively small data sets and may be linked to separate flash areas (Block 0 and Block 1).

The flash memory may be utilized as a non-volatile memory similar to the EEPROM.

Block 0 and Block 1 are each utilized for data storage, and may be managed by periodically aggregating data in a process of writing new data.

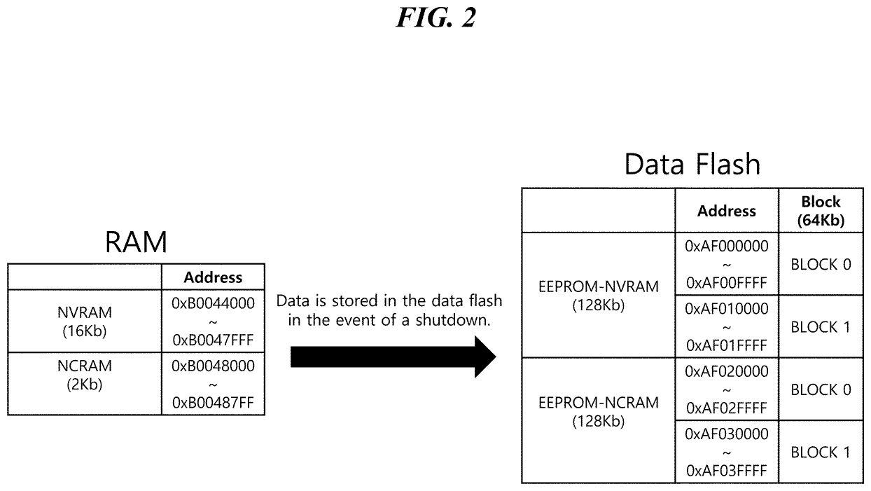

FIG. 2 is a diagram illustrating flash EEPROM emulation according to an embodiment.

Referring to FIG. 2, when a shutdown event occurs in a RAM (NVRAM or NCRAM), data may be stored in the data flash.

NVRAM data may be stored in an EEPROM-NVRAM, and NCRAM data may be stored in an EEPROM-NCRAM. During this process, the data in the RAM may be transferred to a flash memory that is a non-volatile memory to prevent data loss even when power is turned off.

The data in each of the NVRAM and NCRAM may be stored in corresponding blocks (Block 0 and Block 1) of the flash memory. A scheme for storing data based on a certain size (e.g., 64 kb block) and subsequently storing data in a new block when the block is full (flash block aggregation) may be applied.

Referring to FIGS. 1 and 2, the data flash memory may not only store data, but may also manage a state of RAM data and maintain its up-to-date state. Further, data may be transferred block by block, and valid data in a full block may be organized and transferred to a new block. This process allows for efficient data management, eliminating invalid data and leaving only valid data.

The RAM data is transferred to a non-volatile flash memory in a shutdown situation, preventing data loss and enabling valid data in the flash memory to be restored back to the RAM upon initialization (rebooting) so that tasks can be continuously performed.

According to an embodiment, it is possible to minimize storage time and resources and increase a likelihood of real-time data storage by defining the RAM data size as a small one.

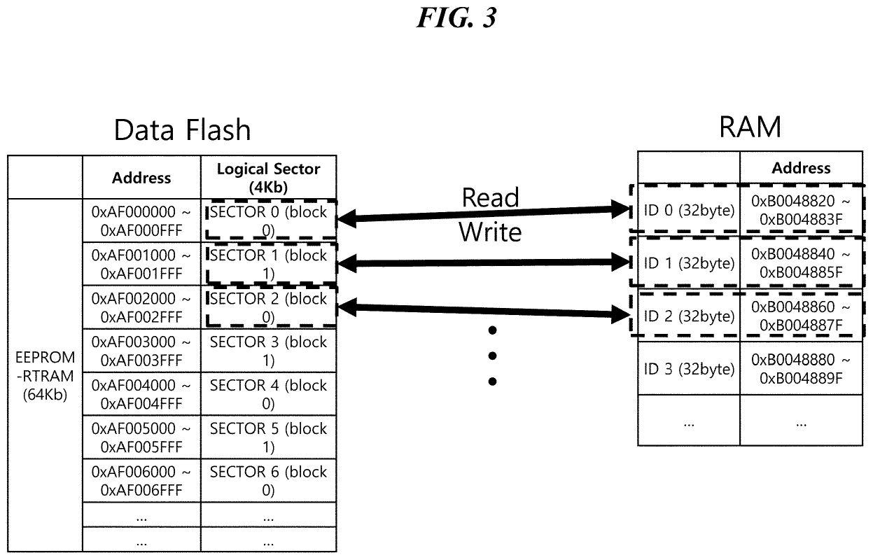

FIG. 3 is a diagram illustrating flash EEPROM emulation according to an embodiment.

Referring to FIG. 3, a left side of FIG. 3 shows the data flash memory, which may be utilized as a non-volatile memory such as an EEPROM.

An address area is designated as 0×AF000000˜0×AF006FFF, which may represent an EEPROM-TRAM (64 kb).

The flash memory is divided into logical sectors. A size of each sector may be 4 kb.

For example, each sector may be structured as follows:
SECTOR 0 (Block 0): 0×AF000000˜0×AF000FFF
SECTOR 1 (Block 0): 0×AF001000˜0×AF001FFF
SECTOR 2 (Block 0): 0×AF002000˜0×AF002FFF
SECTOR 3 (Block 1): 0×AF003000˜0×AF003FFF

Further, each block (Block 0 or Block 1) includes several sectors and may be used for data writing or reading.

A right side of FIG. 3 shows a RAM that is a volatile memory, and backup may be required since data is lost when power is turned off.

RAM data may be stored in 32-byte units, and addresses may be distinguished by IDs.

For example, the addresses may be distinguished by IDs as follows:
ID 0:0×B0048820˜0×B004883F
ID 1:0×B0048840˜0×B004885F
ID 2:0×B0048860˜0×B004887F
ID 3:0×B0048880˜0×B004889F

In an embodiment, the ID data in the RAM may be mapped to sectors in the data flash memory.

For example, ID 0 data may be written to and read from SECTOR 0.

ID 1 data may be linked to SECTOR 2.

ID 2 data may be written to SECTOR 4.

Thus, data mapping is performed in 32-byte data units, and data in the RAM may be stored in the flash memory.

In the case of data movement, a “write” may be a task of storing the data in the RAM to the data flash memory. This may be primarily used during shutdown or data backup.

Furthermore, “read” may be a task of restoring data stored in flash memory back to the RAM. This may be primarily performed during rebooting or data initialization.

In the flash memory, data may be managed in block and sector units, the RAM data may be efficiently distributed and stored in small sectors of the flash memory, and the sectors may be set to e.g., 4 KB for high efficiency of write and read tasks.

According to an embodiment, the RAM data may be managed in 32-byte units by IDs. Such small data units may be advantageous for real-time data management or backup.

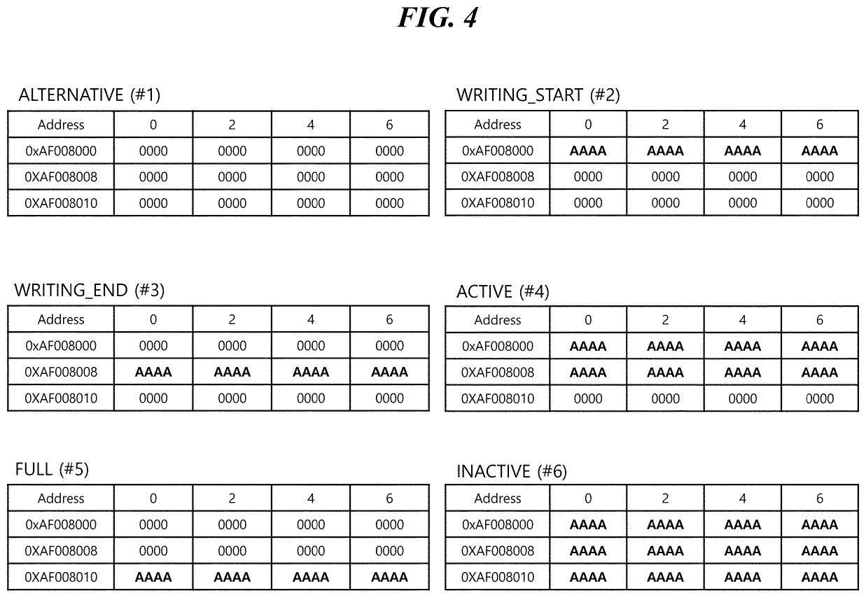

FIG. 4 is a diagram illustrating block and data definitions according to an embodiment.

Referring to FIG. 4, flash blocks may be defined based on a block address and specific data state of the data flash memory according to six states (Alternative, Writing Start, Writing End, Active, Full, and Inactive), as follows.

### 1. Alternative (#1)

In the present specification, Alternative (#1) may be used to mean alternative and may indicate that a block is in an initial state in which data has not yet been written.

According to an embodiment, in Alternative, all addresses (0, 2, 4, and 6) may be initialized to 0000.

An address area may include 0×AF000800, 0×AF000808, and 0×AF000810 (specific address areas of the flash block), and the blocks are empty because a write operation has not yet begun, which may indicate a waiting state for a next operation.

### 2. Writing Start (#2)

In the present specification, “Writing Start” (#2) may be used to mean the start of writing and may indicate a state in which writing of data to a block starts.

In an embodiment, a specific value “AAAA” has been written at a first address (0×AF000800), and data has not yet been written at the remaining addresses.

The address area may include 0×AF000800, 0×AF000808, and 0×AF000810, which indicate that a first write operation has been performed.

### 3. Writing End (#3)

In the present specification, “Writing End” (#3) may be used interchangeably with writing end and may indicate a state in which writing to blocks has ended, i.e., a state in which data has been completely written.

In an embodiment, this may include a state in which all address values are recorded as AAAA, and the address area includes 0×AF000800, 0×AF000808, and 0×AF000810, which indicate a state in which data cannot be additionally written and may include a state in which the block is ready to transition to the active state.

### 4. Active (#4)

In the present specification, Active (#4) may be used to mean active and may indicate a state in which the block has transitioned to the active state.

According to an embodiment, this may include a state in which all address values are set to AAAA and valid data is currently held.

The address area may include 0×AF000800, 0×AF000808, and 0×AF000810, and data may be read or managed in the active state.

### 5. Full (#5)

In the present specification, Full (#5) may be used to mean full and may indicate a state in which the block is full.

In an embodiment, this may include a state in which data has been written to all addresses, no more data can be written, and block swap may be required.

The address area may include 0×AF000800, 0×AF000808, and 0×AF000810, and the block is full and a new block is required for additional writing.

### 6. Inactive (#6)

In the present specification, Inactive (#6) may be used to mean inactive and may indicate a state in which the block is inactive, i.e., a state in which the block no longer includes valid data.

According to an embodiment, this may include that only a first address value is maintained as AAAA, and other values are initialized to 0000.

The address area may include 0×AF000800, 0×AF000808, and 0×AF000810, which indicate a state in which block swap or deletion is required.

According to an embodiment, in the state of the block, the validity and availability of data in the flash memory can be managed, the state sequentially transitions according to a data flow, and an operation in each state may be designed to ensure the integrity of the data. This makes it possible to clearly show memory values in each state and help the system accurately ascertain a current state of the block.

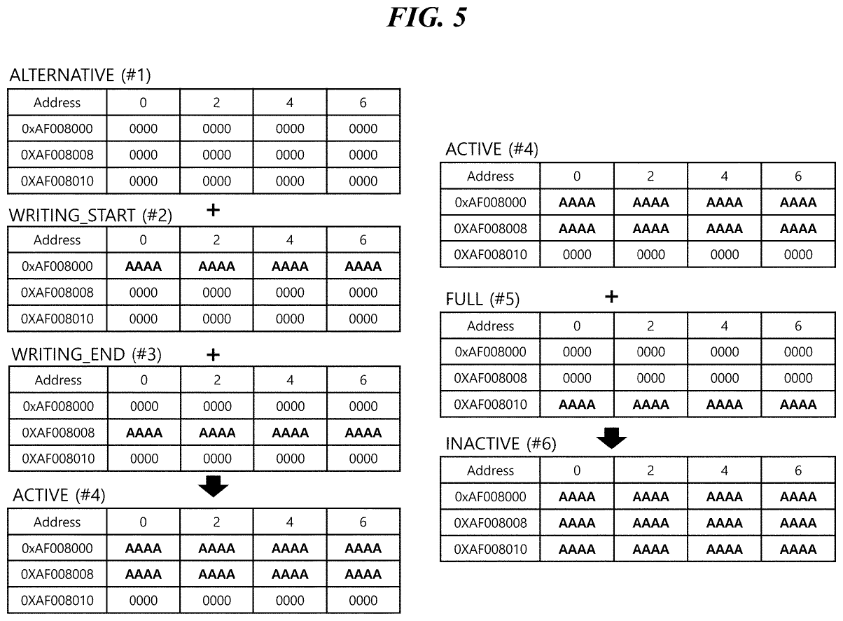

FIG. 5 is a diagram illustrating definition of a block and data according to an embodiment.

Referring to FIG. 5, in an embodiment, when data writing starts in the initial state, AAAA may be recorded at the first address and the block may transition to a writing start state, as in Alternative (#1)→Writing Start (#2).

In an embodiment, when data is written to all addresses, the block may enter a writing end state, as in Writing Start (#2)→Writing End (#3).

In an embodiment, when data is determined to be valid, the block may transition to the active state, as in Writing End (#3)→Active (#4).

In an embodiment, a block may enter a full state in which no more data can be written when the block is full, as in Active (#4)→Full (#5).

Further, in an embodiment, data may be transferred to a new block, which may transition to the inactive state, as in Full (#5)→Inactive (#6).

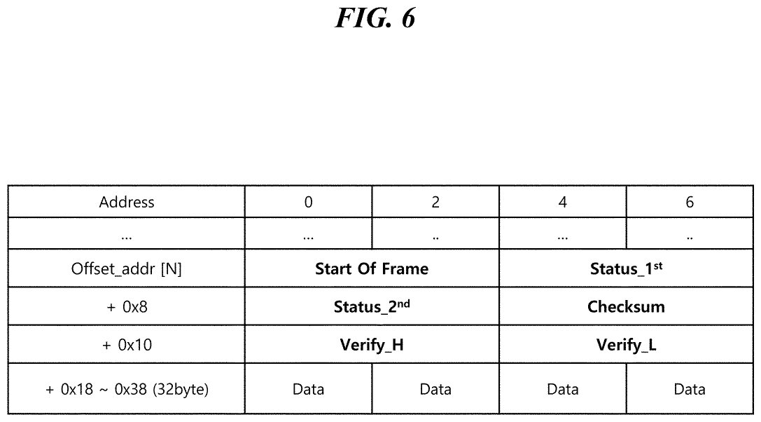

FIG. 6 is a diagram illustrating definitions of a block and data according to an embodiment.

Referring to FIG. 6, a data header includes information for managing a state of data and may consist of 24 bytes. In an embodiment, 32 bytes may be added and a total of 56 bytes of data may be stored.

Start of frame (SOF) may be used herein with the same meaning as the start of a frame and may be information indicating a starting point of data. This may indicate that stored data frames has started correctly.

Status_1st may be used herein with the same meaning as the first state and may be a flag for verifying whether a first header has been well created. This allows verification of a first step of data writing.

Status_2nd may be used herein with the same meaning as the second state and may be a flag for verifying whether a second header has been well created. This allows verification of a second step of data writing.

Checksum may be used herein with the same meaning as checksum and may be a value used to verify the integrity of stored data. This makes it possible to support data error detection and correction.

Verify_H and Verify_L may be used herein with the same meanings as verification H and verification L, and “Verify_H/L” may be used with the same meaning as verification high/low (H/L). These may be flags for verifying whether data is valid or invalid, and 0 indicates that the data is valid.

According to an embodiment, data is stored in 32-byte units, and each data block may be structured as follows:

According to an embodiment, a header and data are stored separately using an offset address as a reference, and a data state may be managed based on a state of each field. This makes it possible to determine the validity of the data in real time and perform tasks such as data restoration, deletion, and rewriting when necessary.

According to an embodiment, the start of frame, Status_1st, and Status_2nd are used to verify a data write process step by step, and Verify_H/L makes a final determination of the validity of the data possible.

It is possible to perform data management, extend the lifespan of the flash memory, and improve the efficiency of data storage and management by defining the data header and determining the state of the data based on the header state in this manner.

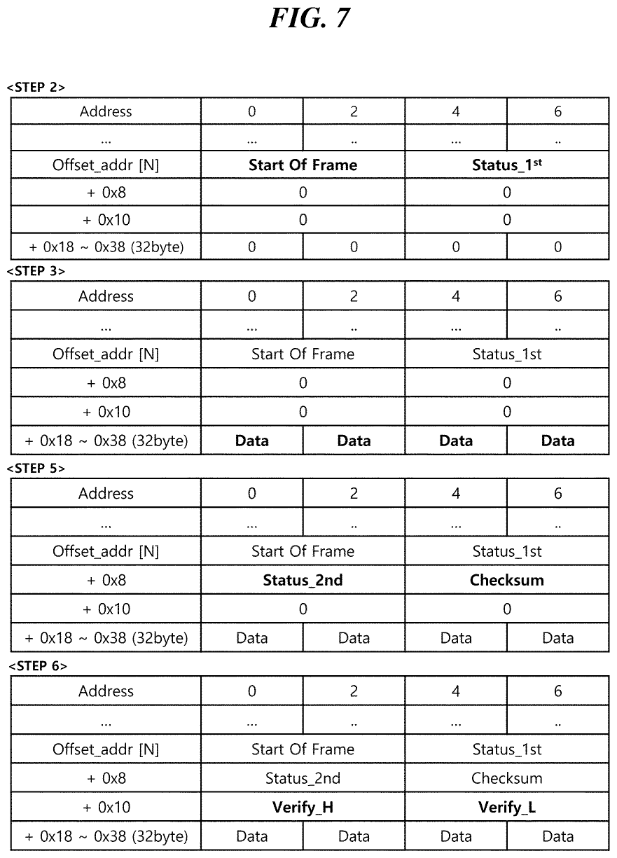

FIG. 7 is a diagram illustrating a logic sequence for storing data according to an embodiment.

In FIG. 7, the logic sequence for storing data is visually described step by step, and the logic sequence, according to an embodiment, is described in detail below.

### Step 1: Search for Empty Space

Addresses without a start of frame (SOF) may be searched for from the top of the block to find the empty space in which data can be stored.

The search is performed in 56-byte units and may be a process of finding a first empty space in which data can be stored.

### Step 2: Create First Header

After the empty space is found, the first header may be written.

The first header may include the start of frame (SOF) and Status_1st.

The start of frame (SOF) may be defined as a flag indicating the start of data.

Status_1st may be a flag for checking whether the first header has been written normally.

### Step 3: Create Data

When creation of the first header is completed, data may be written to the space.

The data may be 32 bytes of information desired to be stored by the user.

### Step 4: Calculate Checksum

After the data is stored, the checksum may be calculated based on the stored data.

The checksum is a value used to verify the integrity of the data and may be used to verify whether data has been modified.

### Step 5: Create Second Header

When the calculated checksum values match, a second header may be created.

The second header may include Status_2nd that is a flag indicating whether the second header has been used normally, and a checksum that is the calculated checksum.

### Step 6: Invalidate Previous Data

Data may be created in a Verify H/L area of existing data to indicate that the data is invalid.

Verify H and Verify L may be used as flags indicating a state (valid/invalid) of the current data.

In an embodiment, when new data is written, previous data may be invalidated and become invalid.

According to an embodiment, in steps 1 and 2, an empty space may be found and the start of frame and Status_1st may be recorded. Thereafter, data may be created in step 3, a checksum may be calculated based on the data in step 4, the Status_2nd and the checksum may be recorded when the checksums match in step 5, and a Verify H/L flag of the previous data may be invalidated to maintain the validity of the new data in step 6.

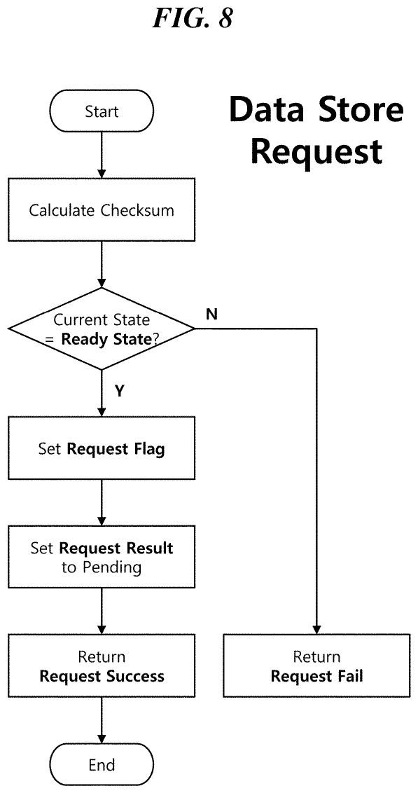

FIG. 8 is a diagram illustrating a sequence of data storage request according to an embodiment.

According to the embodiment illustrated in FIG. 8, a main process of a storage logic for real-time data storage includes a data storage request (Data Store Request) and a request result acquisition (Get Request Result), and the logic may be periodically executed in a specific task in an asynchronous manner.

The data storage request may be logic that operates when a user requests to store data. This process, according to an embodiment, may be performed in the following order:

### Start

The process starts.

### Calculate Checksum

Calculate a checksum based on data to be stored to verify the integrity of the data.

### Current State=Ready State?

Check whether a current state of the real-time RAM state machine is the ready state.

Yes: When the real-time RAM state machine is in the ready state, the process proceed to the next step.

No: When the real-time RAM state machine is not in the ready state, Request Fail is returned and the process ends.

### Set Request Flag

Set the request flag. This may indicate that the data storage request has been received.

### Set Request Result to Pending

A request result is changed to a pending state. This may indicate that data storage processing is in progress.

### Return Request Success

Successful reception of the request is returned to the user.

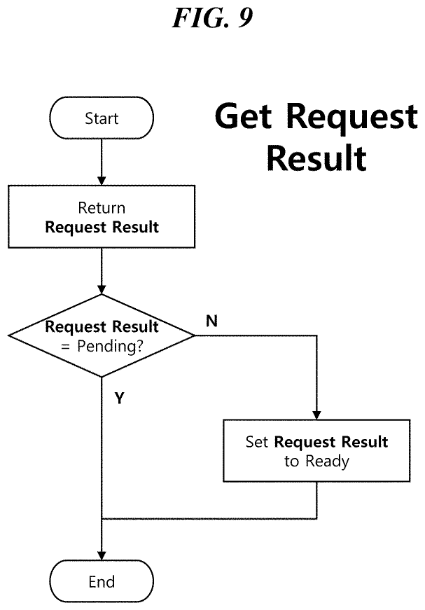

FIG. 9 is a diagram illustrating a sequence of request result acquisition according to an embodiment.

Referring to FIG. 9, the request result acquisition (Get Request Result) may indicate logic for verifying a current request result. This process, according to an embodiment, may be performed in the following order.

### Start

The process starts

### Return Request Result

A state of the current request result is returned

### Request Result=Pending?

Check whether the returned request result is in the pending state.

Yes: When data storage is still being processed, the process ends without performing any task.

No: When the data storage has been completed or has failed, the process proceed to the next step.

### Set Request Result to Ready

A request result is set to the ready state to prepare to receive a next request.

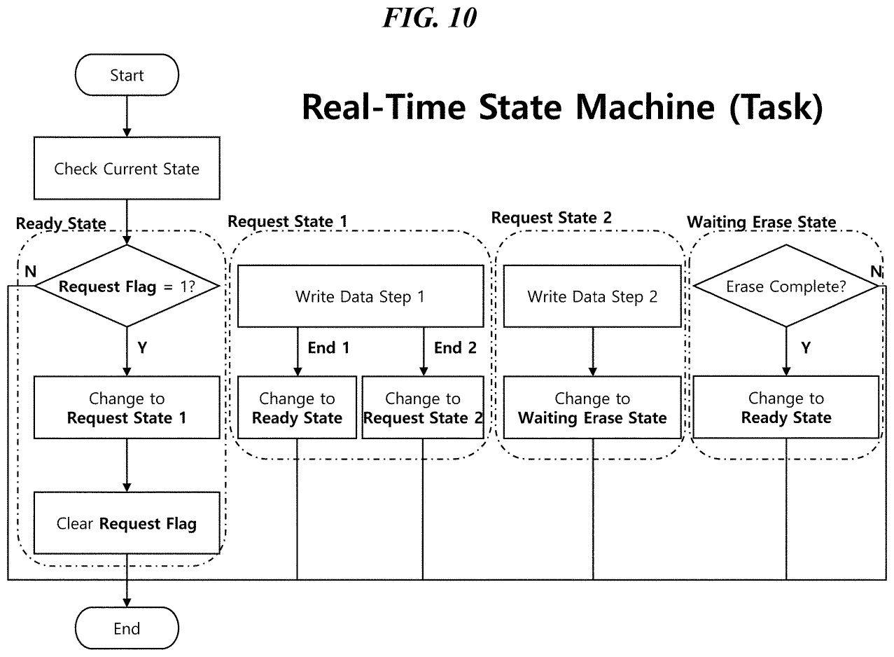

FIG. 10 is a diagram illustrating a sequence of a real-time state machine according to an embodiment.

Referring to FIG. 10, the state of the real-time RAM state machine according to an embodiment are as follows:

### Ready State

Verify the request flag to check whether there is a new request.
When there is no request (N), the task ends.
When there is a request (Y), the state is changed to request state 1 and the request flag is initialized.

### Request State 1

Perform a write step 1 task.

Depending on task results:

Return to the ready state (end1) or proceed to request state 2 (end2).

### Request State 2

Perform a write step 2 task.
When the task is completed, the state is changed to a waiting erase state

### Waiting Erase State

Check when data erasure is completed.
When erasure is completed (Y), the state is changed to the ready state to prepare for reception of the next request, and when the erasure is not completed (N), a waiting state is kept again.

### Process Flow

### Start

The real-time RAM state machine starts and the current state is verified.

### Check Ready State

Check whether the request flag is set.

The process ends when no request is made, and the process proceeds to the next step when a request is made.

### Execute Write Data Step 1 (Request State 1)

Write data step 1 is executed and the process proceeds to the next state according to a task result.

### Execute Write Data Step 2 (Request State 2)

Write data step 2 is executed, and when the task is completed, switching to a pending erase state occurs.

### Verify Erase Completion (Waiting Erase State)

Check whether the erasure task is completed.

Return to the ready state and wait for the next request when the erasure task is completed, and maintain the state and wait for the deletion to be completed when the erasure task is not completed.

According to an embodiment, the state may include four stages: ready state, request state 1, request state 2, and waiting erase state the real-time ram state machine, which makes it possible efficiently process tasks related to real-time data storage, asynchronously manage requests, and efficiently perform state transition and the tasks.

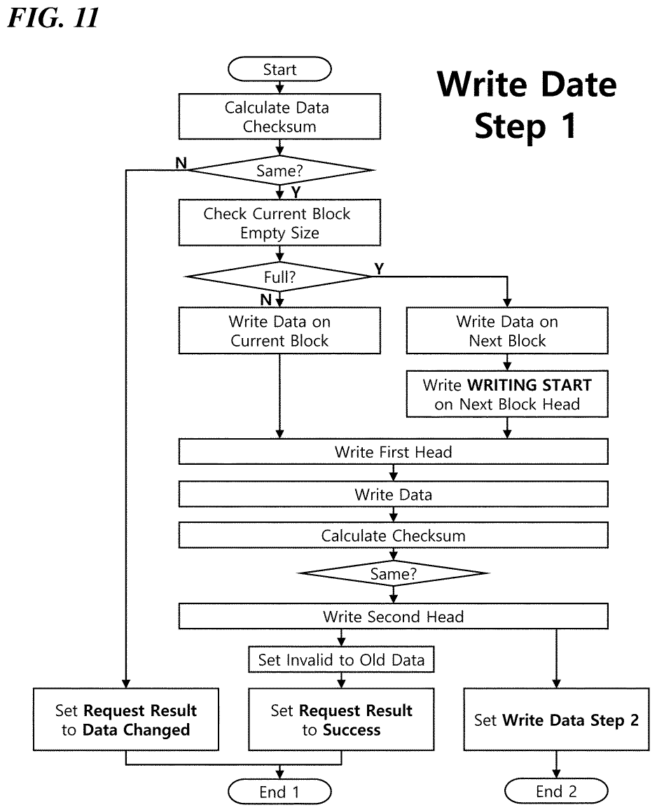

FIG. 11 is a diagram illustrating a sequence of write data step 1 according to an embodiment.

Referring to FIG. 11, according to an embodiment, write data 1 is a first process of writing data, and may be a procedure for checking a state of the current block and creating data. A sequence thereof, according to an embodiment, is as follows.

### Calculate Data Checksum

Calculate a checksum based on the data to verify the integrity of the data.
Set the request result to “Data Changed” and end the process when the data has changed.
Check a remaining space in the current block.
Check when the current block has an empty space to which data can be written.
Determine whether a space is insufficient (FULL), create the data in the current block when the space is sufficient, create the data in the next block when the space is insufficient, and set a writing start (WRITING_START) flag at a header of the new block.

### Write Data

Create the first header and write the data.
Calculate the data checksum again.
Calculate the checksum again to verify the integrity of the data once more after writing the data.
Compare the integrity of the data.
Create the second header, process the previous data as “invalid,” set the request result to “success,” and end the process when the checksums are the same, and set the request result to “data changed” and end the process when the checksums are different.

### Switch to Step 2

Proceed to step 2 when data is created in the next block due to an insufficient space (FULL; full state).

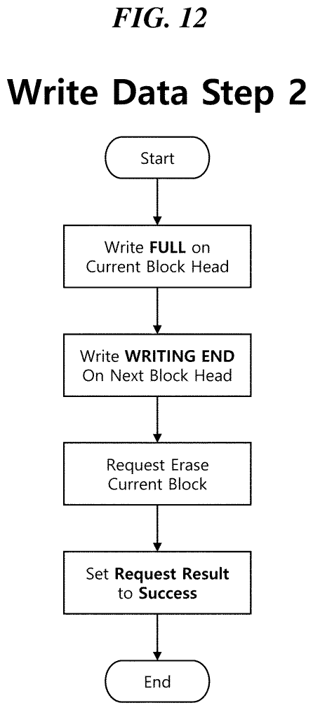

FIG. 12 is a diagram illustrating a sequence of write data step 2 according to an embodiment.

Referring to FIG. 12, according to an embodiment, write data step 2 may be a process of moving data to the next block and organizing a previous block when the current block is full. This process, according to an embodiment, may be performed in the following order.

### Set Header Values of Current Block and Next Block

Set a “FULL” flag at the header of the current block
Set a “WRITING_END” flag at the header of the next block
Request to delete the current block
Send a request to delete this block since the current block is full.

### Set Request Result

Set the request result to “success” to indicate successful completion of the task.

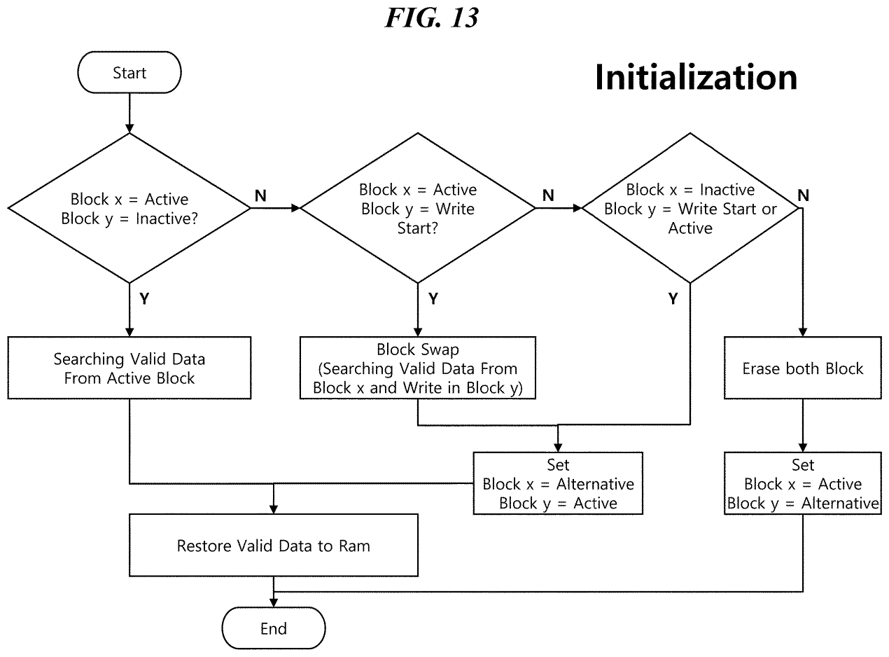

FIG. 13 is a diagram illustrating blocks according to an embodiment.

Referring to FIG. 13, according to an embodiment, initialization according to an embodiment may be a process of checking a block state of the flash memory and determining whether stored data is valid. This process, in an embodiment, may include performing a process of restoring data or deleting incorrect data to restore data to the RAM. The sequence, according to an embodiment, is as follows:

### Block State Check and Processing Logic

1. When Block x=Active and Block y=Inactive
Retrieve valid data from block x and restore the valid data to the RAM when block x is in an active state and block y is in an inactive state.
Then, end the task.
   2. When B Lock x=Active and B Lock y=Write Start
When block x is in the active state and block y is in the “write start” state, this indicates that block swap has been performed and then interrupted, and therefore, the block swap has been completed.
Set block x to Alternative and block y to Active.
Retrieve valid data from block y and restore the valid data to the RAM.

(In an embodiment, block swap is a task for moving data from a block that is full of data to a new block)

3. When Block x=Inactive and Block y=Write Start or Active
Perform the following task when block x is in the inactive state and block y is in the “write start” or active state:
Set block x to Alternative and block y to Active
Retrieve valid data from block y and restore the valid data to the RAM

### 4. Otherwise

Erase and Initialize Both Blocks (block X, Block Y)

According to an embodiment, it is possible to provide an initialization procedure for managing the block state and maintaining the reliability of the data according to the above-described sequence.

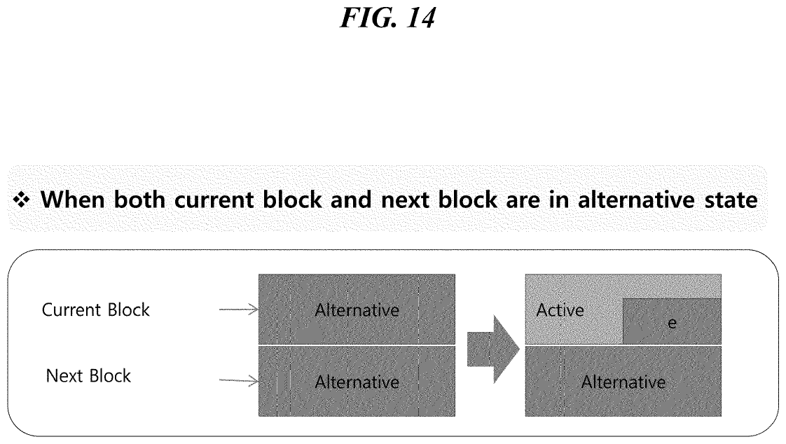

FIG. 14 is a diagram illustrating blocks according to an embodiment.

Referring to FIG. 14, according to an embodiment, when both the current block and the next block are in the alternative state, the block state change may be checked, as follows.

### Initial State

Both the current block and the next block are in the alternative state, which indicates a state in which the block has been initialized or has not yet been activated, i.e., a state in which no data has been written.

### Transition State

The current block transitions to the active state to store data so that a part of a space in the block is activated, and may transition to the ready state for data writing.

In an embodiment, a part of the activated space is indicated by “e,” which may indicate a remaining space available for data storage, or valid data.

### Final State

The current block transitions to the active state and may be used as a block in which data can be stored, and the next block remains in the alternative state, allowing a part of a space in the activated current block to be used for data writing or block management.

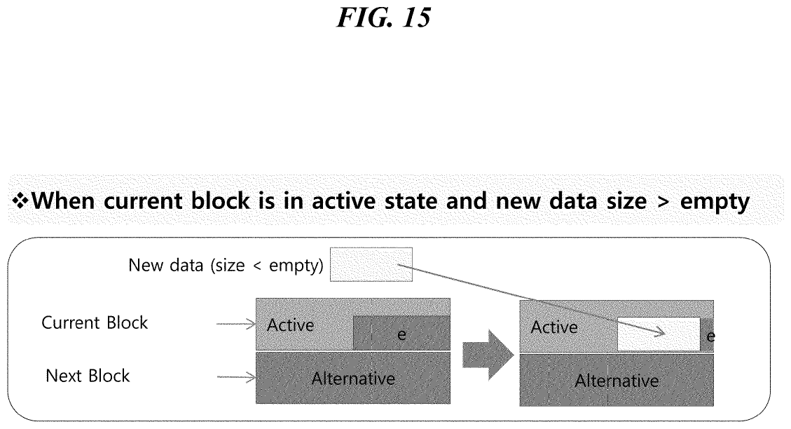

FIG. 15 is a diagram illustrating blocks according to an embodiment.

Referring to FIG. 15, according to an embodiment, a block state change when the current block is in the active state and a size of new data to be newly stored is smaller than a remaining empty space in the current block can be shown, as follows:

### Initial State

The current block has been already activated into the active state and has some data stored therein, and “e” may indicate a remaining empty space in the current block.

The next block is in the alternative state and may be an unused block.

### Data Writing

New data may be written to the empty space “e” in the current block.

“e” may decrease due to the storage of the new data, or there may be no more empty space after the data is stored.

### Final State

The current block remains in the active state and new data may be stored.

The next block is in the alternative state, and may remain in a standby state.

The remaining empty space may be decreased after new data is stored.

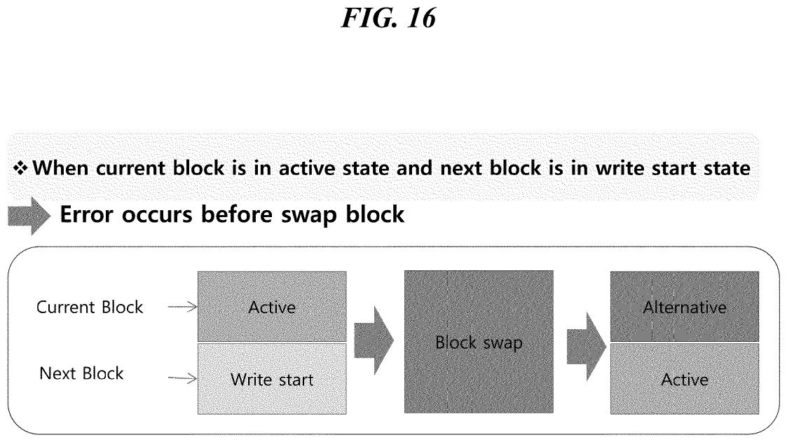

FIG. 16 is a diagram illustrating blocks according to an embodiment.

Referring to FIG. 16, according to an embodiment, when the current block is in the active state and the next block is in a write start state, a block state change in a situation in which an error occurs during a block swap process may be checked, as follows:

### 1. Initial State

The current block is activated in an active state and may currently contain valid data.

The next block is in the write start state and may be a block in which data recording starts, and this may indicate that the block swap process is in progress.

### 2. Block Swap Attempt

The block swap is a data swap task between the current block and the next block, in which data in the active state is transferred to a block in the write start state, and a previous active block is initialized to transition to the alternative state.

In an embodiment, an error may occur in this process, which may cause the data swap task not to be correctly completed.

### 3. Final State

After an error occurs, the state may be restored by performing the block swap task again.

The current block may be transitioned to the alternative state.

The next block may be set to the active state and include valid data.

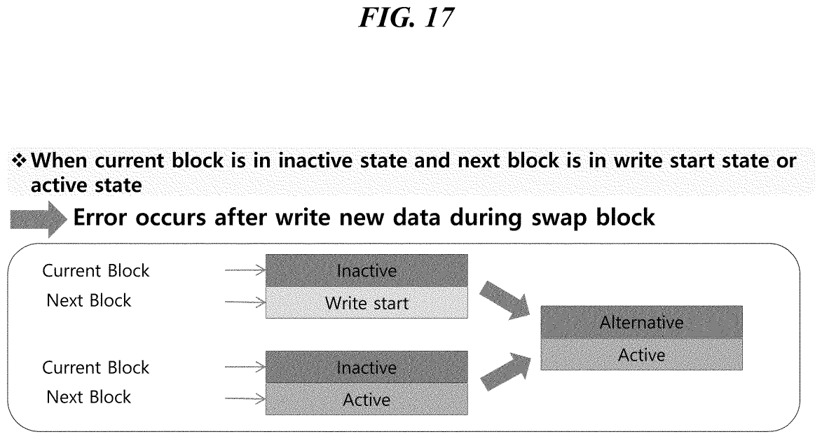

FIG. 17 is a diagram illustrating blocks according to an embodiment.

Referring to FIG. 17, according to an embodiment, when the current block is in the active state and the next block is in the write start or active state, a block state change in a situation in which an error occurs during the block swap process may be checked, as follows:

### 1. Initial State

The current block is in the inactive state and may be a block that no longer has active data, and the next block is in the write start or active state and may be a block to which new data is to be written.

### 2. Block Swap Process

The block swap is a task of moving data to a new block while maintaining the integrity of the data, and during this process, new data may be written to the next block, and the data in the current block may be invalidated and changed to an Alternative state.

### 3. Error Occurrence

An error may occur while new data is being written to the next block.

### 4. Final State

After the error occurs, a recovery task may be performed and the current block may transition to the alternative state.

The next block may be set to the active state and include newly written data.

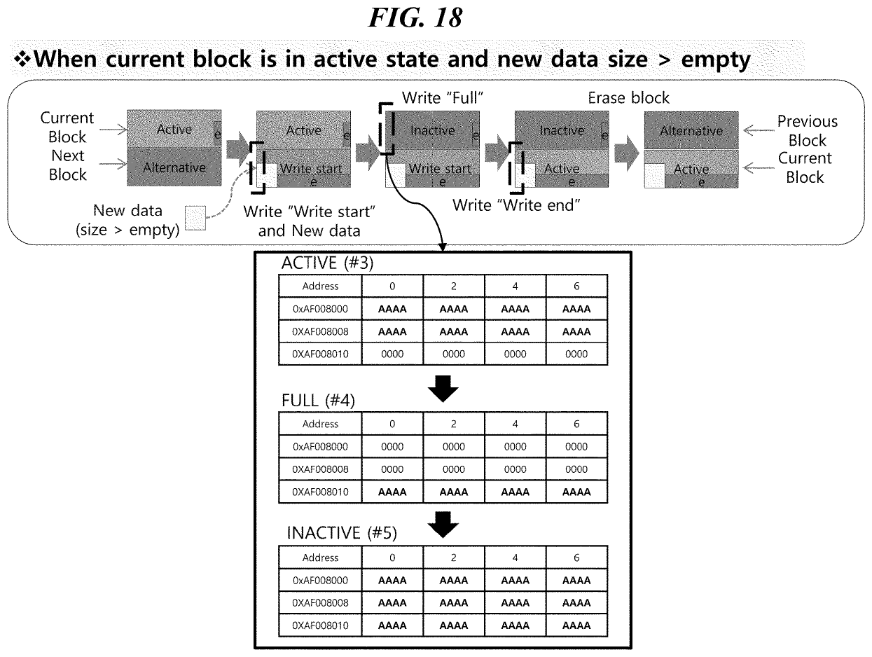

FIG. 18 is a diagram illustrating blocks according to an embodiment.

Referring to FIG. 18, according to an embodiment, a data writing and block state transition process that occurs when the current block is in the active state and a size of the new data is smaller than the empty space can be shown, as follows.

### 1. Initial State

The current block is currently in the active state and is a block to which data can be written, and the next block is currently in the alternative state, that is, a state in which the block is not ready for data writing.

### 2. Data Writing Process

### Step 1: Write New Data and “Write Start”

An empty space (empty) in the current block is checked to record new data.
When there is an insufficient empty space, the next block is activated to prepare for data recording.
A state of the next block is set to “write start” and writing new data starts.

### Step 2: Set State of Current Block to “Full”

The state is changed to “full” to indicate that the current block is full.

### Step 3: Write “Write End” to Next Block

Change the state of the next block to “write end” to indicate the end of data recording after completing data recording.
The next block may then transition to the active state.

### Step 4: Erase Previous Block

Invalidate data in a previous current block (previous active block)
Change the invalidated block to the alternative state

### 3. Final State

The new data is recorded on the next block, which transitions to the active state and includes the new data.

The previous block transitions to the alternative state after data deletion is completed.

The description of the storage method described herein is equally applicable to respective embodiment of the storage device and the recording medium, and repeated descriptions have been omitted below.

The terms “include,” “configure,” and “have” described above mean that a component can be included unless otherwise specifically stated, and therefore should be construed as further including other components rather than excluding the other components. All terms including technical or scientific terms have the same meaning as generally understood by those having ordinary skill in the art to which the present disclosure pertains, unless otherwise defined. Terms commonly used, such as terms defined in a dictionary, should be construed as being consistent with the meaning in the context of the related art, and should not be construed in an ideal or overly formal sense unless explicitly defined in the present disclosure.

Each element of the apparatus or method in accordance with embodiments of the present disclosure may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

The above description is merely illustrative of the technical idea of the present disclosure, and those having ordinary skill in the art to which the present disclosure pertains can make various modifications and variations without departing from the essential characteristics of the present disclosure. Therefore, the embodiments disclosed in the present disclosure are not intended to limit the technical idea of the present disclosure but are intended to explain the technical idea, and the scope of the technical idea of the present disclosure is not limited by these embodiments. The scope of protection of the present disclosure should be construed by the claims below, and all technical ideas within the equivalent scope should be construed as being included in the scope of the rights of the present disclosure.

What is claimed is:

1. A real-time data storage method using flash electrically erasable programmable read-only memory (EEPROM) emulation, the real-time data storage method comprising:
defining a block header and determining a state of a block as one of an alternative state, a write start state, a write end state, an active state, a full state, or an inactive state based on a state of the block header;
defining a data header as at least one of start of a frame, a first state, a second state, checksum, or verification high/low (H/L), and determining a state of the data based on the state of the data header; and
periodically performing storage logic including data storage request and request result acquisition to store the data in real time,
wherein the storage logic includes:
finding an empty space to which new data can be written in the block,
writing a first header including the start of the frame and the first state to the empty space,
writing data,
calculating a checksum using the data,
writing a second header including the second state and the checksum based on determining that the checksum is the same, and
writing the data to the verification H/L of existing data to process the data as invalid data.

2. The real-time data storage method of claim 1, wherein:
performing the data storage request includes:
calculating a checksum,
setting a value of a request flag based on determining that a state of a real-time RAM state machine is a ready state,
setting a request result to a pending state, and
returning a request success; and
performing the request result acquisition includes:
returning the request result, and
setting the request result to a ready state based on determining that the request result is not pending.

3. The real-time data storage method of claim 1, further comprising returning a request failure based on determining that a state of a real-time random access memory (RAM) state machine is not a ready state.

4. The real-time data storage method of claim 1, wherein determining a state of a real-time random access memory (RAM) state machine includes determining that the real-time RAM state machine is in one of a ready state, a request state 1, a request state 2, or a pending erase state.

5. The real-time data storage method of claim 4, further comprising:
checking a current state of the real-time RAM state machine; and
performing one of a ready state logic, a request state 1 logic, a request state 2 logic, or a pending erase state logic based on the current state of the real-time RAM state machine.

6. The real-time data storage method of claim 5, wherein:
performing one of the ready state logic, the request state 1 logic, the request state 2 logic, or the pending erase state logic includes performing the ready state logic based on the current state of the real-time RAM state machine being the ready state; and
performing the ready state logic includes:
determining whether a value of a request flag is 1,
changing the state of the real-time RAM state machine to request state 1 based on determining that the value of the request flag is 1, and
clearing the value of the request flag.

7. The real-time data storage method of claim 5, wherein:
performing one of the ready state logic, the request state 1 logic, the request state 2 logic, or the pending erase state logic includes performing the request state 1 logic based on the current state of the real-time RAM state machine being request state 1; and
performing the request state 1 logic includes:
performing a write data step 1, and
changing the state of the real-time RAM state machine to a ready state or request state 2 according to a result of performing write data step 1.

8. The real-time data storage method of claim 5, wherein:
performing one of the ready state logic, the request state 1 logic, the request state 2 logic, or the pending erase state logic includes performing the request state 2 logic based on the current state of the real-time RAM state machine being request state 2; and
performing the request 2 state logic includes:
performing a write data step 2, and
changing the state of the real-time RAM state machine to a pending erase state.

9. The real-time data storage method of claim 5, wherein:
performing one of the ready state logic, the request state 1 logic, the request state 2 logic, or the pending erase state logic includes performing the pending erase state logic based on the current state of the real-time RAM state machine being the pending erase state; and
performing the pending erase state logic includes:
determining whether the erasure is completed, and
changing the state of the real-time RAM state machine to a ready state in response to the erasure being completed.

10. The real-time data storage method of claim 7, wherein performing the write data step 1 includes:
calculating a checksum of the data;
determining whether the checksums of the data are the same;
checking a remaining space of a current block based on determining that the checksums of the data are the same;
writing the data to the current block based on determining that the remaining space is not full;
setting the existing data as invalid; and
setting a request result as a request success.

11. The real-time data storage method of claim 7, wherein performing the write data step 1 includes:
calculating checksums of the data;
determining whether the checksums of the data are the same; and
setting the request result as data changed based on determining that the checksums of the data are different.

12. The real-time data storage method of claim 7, wherein performing the write data step 1 includes:
calculating a checksum of the data;
determining whether the checksums of the data are the same;
checking a remaining space of a current block based on determining that the checksums of the data are the same;
writing the data to a block next to the block based on determining that the remaining space is full; and
setting write data step 2.

13. The real-time data storage method of claim 8, wherein performing the write data step 2 includes:
writing a full value to a current block header;
writing a write end value to a block header next to the current block header;
requesting deletion of the full value of a current block; and
setting the request result as a request success.

14. The real-time data storage method of claim 1, further comprising an initialization step of processing the data according to the state of the block.

15. The real-time data storage method of claim 14, wherein the initialization step includes:
determining whether block x is in the active state and block y is in the inactive state, the block including block x and block y;
finding valid data in an active block based on determining that block x is in the active state and block y is in the inactive state; and
restoring the valid data into a random access memory (RAM).

16. The real-time data storage method of claim 14, wherein the initialization step includes:
determining whether block x is in the active state and block y is in the inactive state, the block including block x and block y;
determining whether block x is in the active state and block y is in the write start state based on determining that block x is not in the active state and block y is not in the inactive state;
performing block swap and setting block x to the alternative state and block y to the active state based on determining that the block x is in the active state and block y is in the write start state; and
restoring the valid data into a random access memory (RAM).

17. The real-time data storage method of claim 14, wherein the initialization step includes:
determining whether block x is in the active state and block y is in the inactive state, the block including block x and block y;
determining whether block x is in the active state and block y is in the write start state based on determining that block x is not in the active state and block y is not in the inactive state;
determining whether block x is in the inactive state and block y is in the write start state or the active state based on determining that block x is not in the active state and block y is not in the inactive state;
setting block x to the alternative state and block y to the active state based on determining that the block x is in the inactive state and block y is in the write start state or the active state; and
restoring the valid data into a random access memory (RAM).

18. The real-time data storage method of claim 14, wherein the initialization step includes:
determining whether block x is in the active state and block y is in the inactive state, the block including block x and block y;
determining whether block x is in the active state and block y is in the write start state based on determining that block x is not in the active state and block y is not in the inactive state;
determining whether block x is in the inactive state and block y is in the write start state or the active state based on determining that block x is not in the active state and block y is not in the inactive state;
deleting the block x and the block y based on determining that block x is not in the inactive state and block y is not in the write start state or the active state; and
setting block x to the active state and block y to the alternative state.

19. A computer-readable non-transitory medium having stored thereon instructions that, when executed by one or more processors, cause the one or more processors to:
define a block header and determine a state of a block as one of an alternative state, a write start state, a write end state, an active state, a full state, or an inactive state based on a state of the block header;
define a data header as at least one of start of a frame, a first state, a second state, checksum, or verification high/low (H/L), and determine a state of the data based on the state of the data header; and
periodically perform storage logic including data storage request and request result acquisition to store the data in real time,
wherein the storage logic includes:
finding an empty space to which new data can be written in the block,
writing a first header including a start of the frame and the first state to the empty space,
writing data,
calculating a checksum using the data,
writing a second header including the second state and the checksum based on determining that the checksum is the same, and
writing the data to the verification H/L of existing data to process the data as invalid data.

20. A real-time data storage device for emulating a flash electrically erasable programmable read-only memory (EEPROM), the real-time data storage device comprising:
a memory configured to store computer-readable instructions; and
one or more processors configured to execute the computer-readable instructions to:
define a block header and determine a state of a block as one of an alternative state, a write start state, a write end state, an active state, a full state, or an inactive state based on a state of the block header;
define a data header as at least one of start of a frame, a first state, a second state, checksum, or verification high/low (H/L), and determine a state of the data based on the state of the data header; and
periodically perform storage logic including data storage request and request result acquisition to store the data in real time,
wherein the storage logic includes:
finding an empty space to which new data can be written in the block,
writing a first header including the start of the frame and the first state to the empty space,
writing data,
calculating a checksum using the data,
writing a second header including the second state and the checksum based on determining that the checksum is the same, and
writing the data to the verification H/L of existing data to process the data as invalid data.
